(19) United States
(12) Patent Application Publication
(10) Pub. No.: US 2012/0026374 A1
(43) Pub. Date: Feb. 2, 2012

(54) IMAGE SENSOR AND IMAGE PICKUP APPARATUS

(75) Inventor: Kenichi Kido, Osaka (JP)

(73) Assignee: SANYO ELECTRIC CO., LTD., Osaka (JP)

(21) Appl. No.: 13/189,941

(22) Filed: Jul. 25, 2011

(30) Foreign Application Priority Data
Jul. 27, 2010 (JP) 2010-168379

(51) Int. Cl. H04N 3/12

(52) U.S. Cl. 348/332; 348/E05.025

(57) ABSTRACT

An image sensor includes: a plurality of photoelectric transduction elements arranged in a two-dimensional array; and an output unit outputting a video signal generated from electric charges accumulated by the plurality of photoelectric transduction elements, and sync codes corresponding to a horizontal sync signal and a vertical sync signal indicating predetermined intervals, as low voltage differential signals synchronized with a prescribed clock. The output unit outputs only the sync code corresponding to a horizontal sync signal as a low voltage differential signal in a blanking period, among the video signal and the sync codes corresponding to a horizontal sync signal and a vertical sync signal.

This application is based on Japanese Patent Application No. 2010-168379 filed with Japan Patent Office on Jul. 27, 2010, the entire content of which is hereby incorporated by reference.

### BACKGROUND OF THE INVENTION

1. Field of the Invention

The present invention relates to an image sensor and an image pickup apparatus, and more particularly to an image sensor including photoelectric transduction elements and an image pickup apparatus including the image sensor.

2. Description of the Related Art

There is a conventional image sensor which stops operation of its output circuit during a blanking period so as not to consume power in order to reduce power consumption.

A digital camera, in particular when capturing a still image, has to be synchronized in a vertical blanking period with an image sensor having a vertical blanking period during exposure in order to allow the image sensor to perform photoelectric transduction for a prescribed period. For this purpose, in a conventional digital camera using the image sensor which stops operation of its output circuit during a blanking period, a horizontal sync signal is generated based on a clock signal produced by a clock circuit operating independently from the image sensor.

FIG. 7 shows a partial configuration of a conventional digital camera. Referring to FIG. 7, the conventional digital camera includes an LVDS I/F 71 receiving a low-voltage differential signal input from an image sensor, a conversion unit 83 for converting data to a clock different from the clock of the image sensor, a DRAM (Dynamic Random Access Memory) 79 temporarily storing data, and a CPU (Central Processing Unit) 81. LVDS is an abbreviation of “Low Voltage Differential Signaling” which is a digital wired transmission system for a short distance and is a differential interface at relatively high speed with small amplitudes and low consumption power. In order to achieve signal transmission as fast as a few hundred Mbit/s or more, the amplitude of the input/output signal level is reduced to a few hundred mV. Susceptibility to noise resulting from the reduced amplitude is eliminated by the adoption of differential signaling rather than single-ended signaling.

LVDS I/F 71 receives two kinds of low voltage differential signal/video signal from the image sensor. The first kind of low voltage differential signal Clock-P, Clock-N is a clock signal CLK1. The second kind of low voltage differential signal Data-P, Data-N is a video signal, a horizontal sync signal and a vertical sync signal synchronized with the first kind of low voltage differential signal. In the conventional image sensor, the first kind of low voltage differential signal Clock-P, Clock-N and the second kind of low voltage differential signal Data-P, Data-N are not output during a vertical blanking period, as described above. Therefore, conversion unit 83 generates a vertical sync signal and a horizontal sync signal synchronized with a clock different from the clock of the image sensor and writes data into DRAM 79 using the generated vertical sync signal and horizontal sync signal.

Conversion unit 83 includes a PLL 73 outputting a clock signal CLK2 at a prescribed frequency, an SRAM (Static Random Access Memory) 75 temporarily storing video signal DAT1 for bringing the video signal DAT1, which is synchronized with the clock signal CLK1, into synchronization with the clock signal CLK2, and a counter 77.

More specifically, LVDS I/F 71 converts the first kind of low voltage differential signal Clock-P, Clock-N input from the image sensor, into the clock signal CLK1 for output to SRAM 75. LVDS I/F 71 outputs video signal DAT1 extracted from the second kind of low voltage differential signal to SRAM 75, outputs a horizontal sync signal HD1 extracted from the second kind of low voltage differential signal to SRAM 75, and outputs a vertical sync signal VD extracted from the second kind of low voltage differential signal to counter 77. The video signal DAT1, the horizontal sync signal HD1, and the vertical sync signal VD are synchronized with the clock signal CLK1.

SRAM 75 writes the video signal DAT1 input in synchronization with the clock signal CLK1 at an address determined based on the clock signal CLK1 and the horizontal sync signal. Thus, the video signal input from the image sensor is temporarily stored into SRAM 75.

PLL 73 generates a clock signal CLK2 having the same cycle as the clock signal CLK1 and outputs the clock signal CLK2 to SRAM 75, counter 77, and DRAM 79. The clock signal CLK1 and the clock signal CLK2 are not synchronized with each other.

Counter 77 calculates a count value Vcnt of the horizontal sync signal and a count value Hcnt of a pixel based on the clock signal CLK2 and the vertical sync signal VD and outputs the vertical sync signal count value Vcnt and the pixel count value Hcnt to DRAM 79 and CPU 81. Counter 77 also generates a horizontal sync signal HD2 synchronized with clock signal CLK2 based on the clock signal CLK2 and the vertical sync signal VD and outputs the horizontal sync signal HD2 to SRAM 75. SRAM 75 reads out the video signal DAT1 temporarily stored in SRAM 75 using the clock signal CLK2 and the horizontal sync signal HD2 and outputs the read signal as a video signal DAT2. DAT1 and DAT2 have the same value but are different in that DAT1 is synchronized with the clock signal CLK1 whereas DAT2 is synchronized with the clock signal CLK2. The address from which SRAM 75 reads out the stored video signal DAT1 is determined by the clock signal CLK2 and the horizontal sync signal HD2.

DRAM 79 stores the video signal DAT2 input from SRAM 75 at a predetermined address for a pixel location specified by the horizontal sync signal count value Vcnt and the pixel count value Hcnt input from counter 77. On the other hand, CPU 11 can determine where in a screen the video signal stored into DRAM 79 is, based on the horizontal sync signal count value Vcnt and the pixel count value Hcnt that are input from counter 77.

The conventional digital camera has to use PLL 73 operating independently from the image sensor in order to generate the horizontal sync signal HD2 in a vertical blanking period, and in addition, has to use SRAM 75 in order to synchronize the video signal with the clock signal CLK2 output by PLL 73.

### SUMMARY OF THE INVENTION

In accordance with an aspect of the present invention, an image sensor includes: a plurality of photoelectric transduction elements arranged in a two-dimensional array; and an output unit outputting a video signal generated from electric charges accumulated by the plurality of photoelectric transduction elements, and sync codes corresponding to a horizontal sync signal and a vertical sync signal indicating predetermined intervals, as low voltage differential signals synchronized with a prescribed clock. The output unit outputs only the sync code corresponding to a horizontal sync signal as a low voltage differential signal in a blanking period, among the video signal and the sync codes corresponding to a horizontal sync signal and a vertical sync signal.

In accordance with another aspect of the present invention, an image pickup apparatus includes an image sensor outputting a video signal generated from electric charges accumulated by a plurality of photoelectric transduction elements, and sync codes corresponding to a horizontal sync signal and a vertical sync signal indicating predetermined intervals, as low voltage differential signals synchronized with a prescribed clock. The image sensor outputs only the sync code corresponding to a horizontal sync signal as a low voltage differential signal in a blanking period, among the video signal and the sync codes corresponding to a horizontal sync signal and a vertical sync signal. The image pickup apparatus further includes an image pickup control unit to control the image sensor. The image pickup control unit determines a timing at which photoelectric transduction terminates after reset of the image sensor, using the sync code corresponding to a horizontal sync signal included in the low voltage differential signal output by the image sensor during the blanking period.

The foregoing and other features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram schematically showing a configuration of a digital still camera in an embodiment of the present invention.

FIG. 2 shows an example of a detailed configuration of a conversion unit as well as an image sensor, an SDRAM, and a CPU.

FIG. 3A to FIG. 3D show the relation between a format of the second kind of low voltage differential signal and a frame valid signal and horizontal and vertical sync signals.

FIG. 4A to FIG. 4D show an example of outputs of an LVDS I/F.

FIG. 5 is a block diagram showing an example of an overall function of the CPU.

FIG. 6A to FIG. 6D show an example of a vertical sync signal, a count value of a horizontal sync signal, and a count value of a pixel, and a mechanical shutter open/closed state.

FIG. 7 shows an example of a partial configuration of a conventional digital camera.

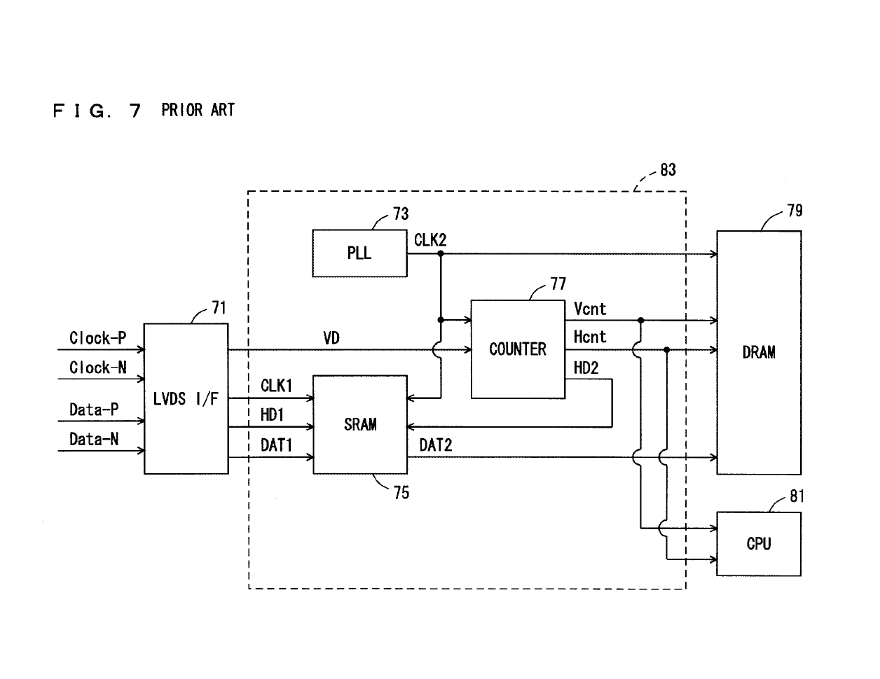

### DESCRIPTION OF THE PREFERRED EMBODIMENTS

The preferred embodiments of the present invention will be described below in conjunction with the drawings. In the following description, the same or corresponding parts are denoted by the same reference characters.

Their names and functions are also the same. Thus, a detailed description thereof will not be repeated.

In the present embodiment, a digital still camera will be described as an example of the image pickup apparatus. The image pickup apparatus is not limited to a digital still camera and may be, for example, a video camera, a mobile phone, or a music player as long as it has a function of imaging a subject.

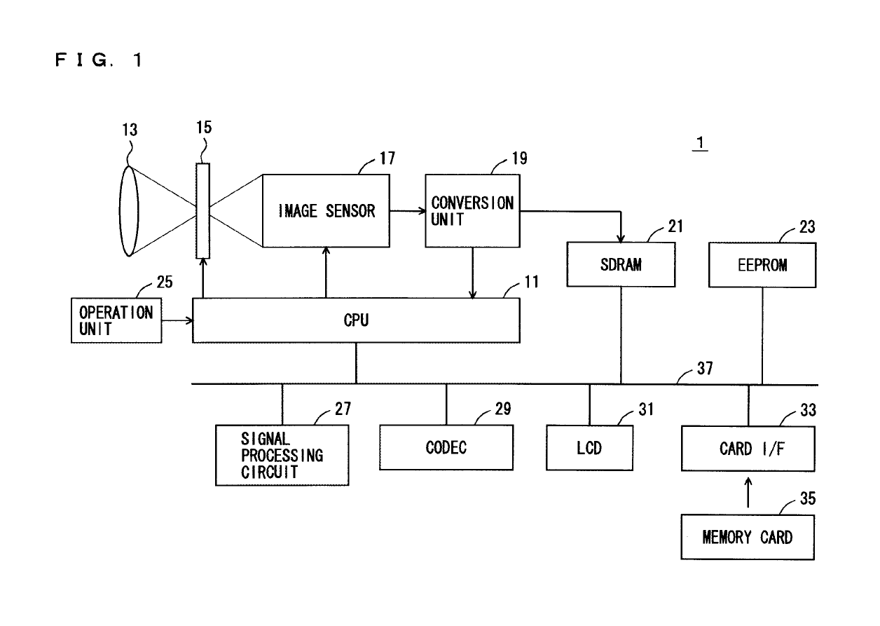

FIG. 1 is a block diagram schematically showing a configuration of a digital still camera in an embodiment of the present invention. Referring to FIG. 1, a digital still camera 1 includes a CPU 11 controlling the entire digital still camera 1, lenses 13 including a focus lens and a zoom lens, an image sensor 17, a mechanical shutter 15 provided between lenses 13 and image sensor 17, a conversion unit 19, an SDRAM (Synchronous Dynamic Random Access Memory) 21, an EEPROM (Electrically Erasable and Programmable Read Only Memory) 23 storing, for example, a program to be executed by CPU 11, a signal processing circuit 27 for image processing, a codec 29, an LCD (Liquid Crystal Display) 31, a card I/F (interface) 33 to which a memory card 35 is attached, and an operation unit 25 accepting a user's operation.

Lenses 13 are provided on a front surface of the body of digital still camera 1. LCD 31 is provided on a back surface of digital still camera 1 that is opposite to the surface having lenses 13. Image sensor 17 is a CMOS (Complementary Metal Oxide Semiconductor) sensor having a plurality of photoelectric transduction elements arranged in a two-dimensional array and converts a video signal generated from electrical charges accumulated by a plurality of photoelectric transduction elements into a low voltage differential signal with the addition of a horizontal sync signal and a vertical sync signal showing predetermined intervals and outputs the low voltage differential signal to conversion unit 19. Image sensor 17 has an image plane vertical to the optical axis of lenses 13.

Image sensor 17 has a photoelectric transduction time controlled by CPU 11. Specifically, when image sensor 17 starts photoelectric transduction, CPU 11 opens mechanical shutter 15 provided between lenses 13 and image sensor 17. When image sensor 17 starts photoelectric transduction, CPU 11 outputs an exposure time and a reset signal to image sensor 17. Upon receiving the reset signal, image sensor 17 resets the photoelectric transduction elements and thereafter starts photoelectric transduction. CPU 11 closes mechanical shutter 15 when the time allowed for image sensor 17 to transduce has elapsed. When CPU 11 closes mechanical shutter 15, the exposure of image sensor 17 ends. Image sensor 17 outputs a video signal when the exposure time has elapsed after the reset of the photoelectric transduction elements is completed. The exposure time depends on the settings input to operation unit 25 by the user. The exposure time may be automatically set by CPU 11 when AE (Automatic Exposure) is set.

Conversion unit 19 extracts a vertical sync signal, a horizontal sync signal, and a video signal from the low voltage differential signal input from image sensor 17 and stores the video signal into SDRAM 21 based on the vertical sync signal and the horizontal sync signal. The address at which the video signal is stored in SDRAM 21 is specified based on the vertical sync signal and the horizontal sync signal. Here, the video signal of one screen that is stored in SDRAM 21 is referred to as image data. The image data is data arranged in the Bayer array in which each pixel is formed of one of R (red), G (green), and B (blue).

Signal processing circuit 27 reads out the image data stored in SDRAM 21 and performs a variety of signal processing on the image data for conversion into the YUV color space represented by a luminance signal and a color-difference signal. Signal processing circuit 27 stores the image data in the YUV format into SDRAM 21.

Signal processing circuit 27 generates an RGB signal from the image data in the YUV format stored in SDRAM 21 and outputs the RGB signal to LCD 31. Thus, an image based on the video signal output by image sensor 17 imaging a subject is displayed on LCD 31. LCD 31 may be replaced with an organic EL (Electro Luminescence) display.

Codec 29, controlled by CPU 11, reads out the image data in the YUV format stored in SDRAM 21, compresses and encodes the image data, and stores the encoded data into SDRAM 21. Here, the image data is compressed and encoded in the JPEG format.

Memory card 35 including a nonvolatile memory is attached to card I/F 33. CPU 11 can access memory card 35 through card I/F 33 to store the encoded data stored in SDRAM 21 into memory card 35 or read out the encoded data stored in memory card 35 for storage into SDRAM 21. Operation unit 25 includes a plurality of keys including a shutter button for accepting an instruction to start picking up an image and accepts a user's operation. Operation unit 25 outputs an image pickup instruction to CPU 11 when the shutter button is pressed.

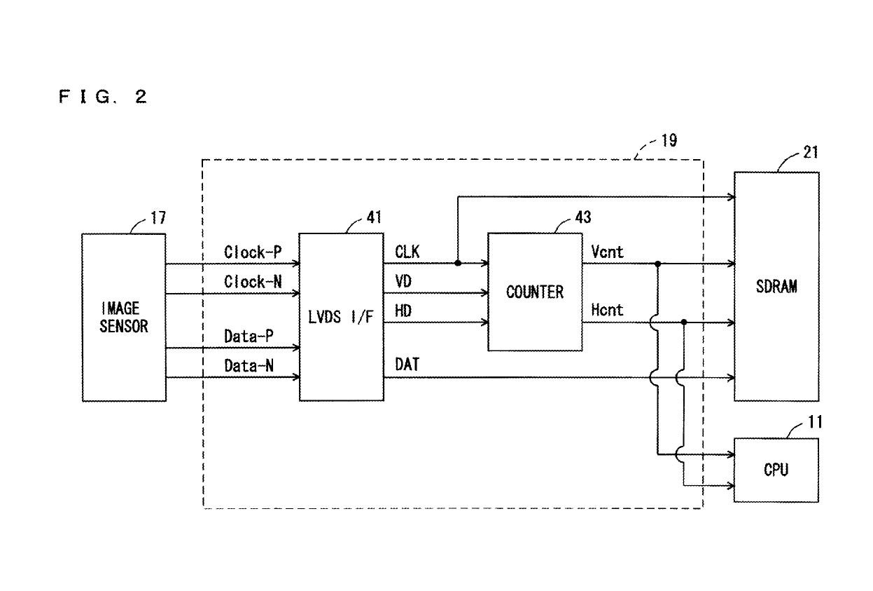

FIG. 2 shows an example of a detailed configuration of the conversion unit as well as the image sensor, the SDRAM, and the CPU. Referring to FIG. 2, conversion unit 19 includes an LVDS I/F 41 receiving a low voltage differential signal from image sensor 17, and a counter 43.

LVDS I/F 41 receives two kinds of low voltage differential signal/video signal from the image sensor. The first kind of low voltage differential signal Clock-P, Clock⁻N is a clock signal CLK. The second kind of low voltage differential signal Data-P, Data-N is a video signal, a horizontal sync signal and a vertical sync signal synchronized with the first kind of low voltage differential signal. LVDS I/F 41 extracts a video signal, a horizontal sync signal, and a vertical sync signal from the second kind of low voltage differential signal based on the first kind of low voltage differential signal. LVDS I/F 41 outputs the clock signal CLK, which is the first kind of low voltage differential signal, to counter 43 and SDRAM 21, outputs a horizontal sync signal HD and a vertical sync signal VD extracted from the second kind of low voltage differential signal to counter 43, and a video signal DAT extracted from the second kind of low voltage differential signal to SDRAM 21. The horizontal sync signal HD, the vertical sync signal VD, and the video signal DAT are synchronized with the clock signal CLK.

Counter 43 calculates a count value Vcnt of the horizontal sync signal and a count value Hcnt of a pixel based on the clock signal CLK, the horizontal sync signal HD, and the vertical sync signal VD, and outputs the horizontal sync signal count value Vcnt and the pixel count value Hcnt to SDRAM 21 and CPU 11. Counter 43 resets the horizontal sync signal count value Vcnt to “0” every time the vertical sync signal VD is input from LVDS I/F 41. Counter 43 increments the horizontal sync signal count value Vcnt by “1” every time the horizontal sync signal HD is input from LVDS I/F 41. Therefore, the horizontal sync signal count value Vcnt shows the location of a line in a screen.

Counter 43 resets the pixel count value Hcnt to “0” every time the horizontal sync signal HD is input from LVDS I/F 41. Counter 43 increments the pixel count value Hcnt by “1” every time a predetermined number of clock pulses of the clock signal CLK input from LVDS I/F 41 is counted. Therefore, the pixel count value Hcnt shows the ordinal of a pixel arranged in a line. Thus, the horizontal sync signal count value Vcnt and the pixel count value Hcnt specify the location of a corresponding pixel arranged in a screen.

It is noted that the clock signal CLK is not input from LVDS I/F 41 in a vertical blanking period, excluding a period in the vicinity of the point of time when the horizontal sync signal HD is input. Since it is not necessary to specify the location of a pixel arranged in a screen during a blanking period, there is no need for counting the pixel count value Hcnt in a blanking period excluding a period in the vicinity of the point of time when the horizontal sync signal is input.

SDRAM 21 stores the video signal DAT input from LVDS I/F 41 at a predetermined address for the location specified by the horizontal sync signal count value Vcnt and the pixel count value Hcnt from counter 43, except in a vertical blanking period during which the video signal DAT is not input.

On the other hand, CPU 11 can determine where in a screen the video signal stored into SDRAM 21 is, based on the horizontal sync signal count value Vcnt and the pixel count value Hcnt input from counter 43.

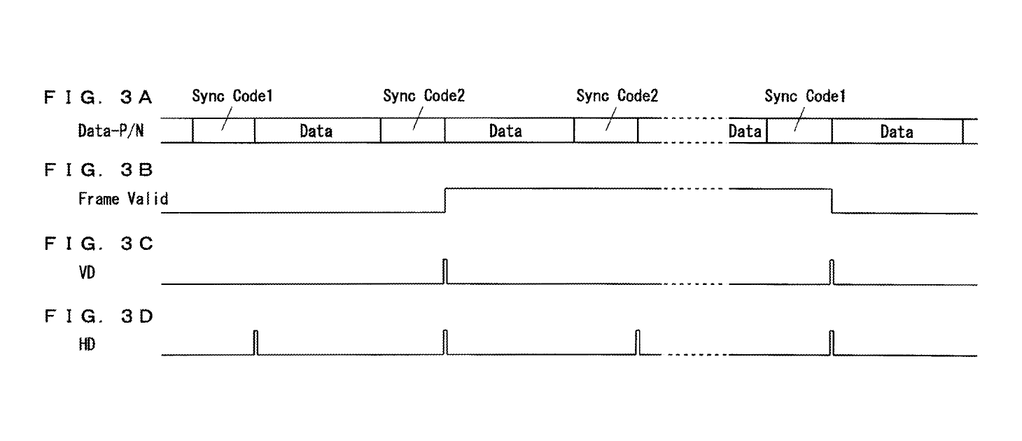

FIG. 3A to FIG. 3D show the relation between a format of the second kind of low voltage differential signal and a frame valid signal and horizontal and vertical sync signals. FIG. 3A shows an exemplary format of the second kind of low voltage differential signal. FIG. 3B shows an exemplary frame valid signal. FIG. 3C shows an exemplary vertical sync signal. FIG. 3D shows an exemplary horizontal sync signal. Referring to FIG. 3A, the second kind of low voltage differential signal Data-P/N is a repetition of one of two kinds of sync codes Sync Code 1 and Sync Code 2 and the following video signal Data. All the two kinds of sync codes Sync Code 1 and Sync Code 2 have the same length, and all the video signals Data have the same length. The sync code Sync Code 2 indicates that the following video signal Data is a valid video signal, in other words, frame data. The sync code Sync Code 1 indicates that the following video signal Data is an invalid video signal, in other words, data in a vertical blanking period. Image sensor 17 in the present embodiment outputs the sync code Sync Code 1 and does not output the video signal Data when the video signal Data is data in a vertical blanking period.

Sync codes may also include a code representing the end of data, in addition to Sync Code 1 and Sync Code 2 representing the start of data. However, in the present embodiment, the code representing the start of the sync signal will suffice in a blanking period, and the code representing the end of data is not output.

Referring to FIG. 3B, the frame valid signal Frame Valid goes High after reception of the sync code Sync Code 2 and goes Low after reception of the sync code Sync Code 1. The period during which the frame valid signal Frame Valid is Low shows a vertical blanking period.

Referring to FIG. 3C, the vertical sync signal VD is an active pulse that goes High when the frame valid signal Frame Valid changes from Low to High or changes from High to Low. Referring to FIG. 3D, the horizontal sync signal HD is an active pulse that goes High immediately after the sync code Sync Code 1 or immediately after the sync code Sync Code 2. The horizontal sync signal HD is an active pulse that goes High immediately after the sync code Sync Code 1 even in the vertical blanking period during which the frame valid signal Frame Valid is Low.

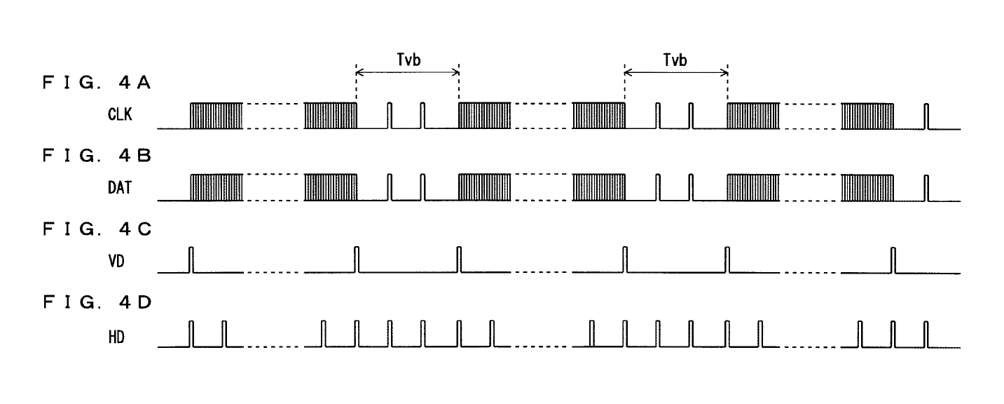

FIG. 4A to FIG. 4D show an example of outputs of the LVDS I/F. FIG. 4A shows the clock signal CLK. FIG. 4B shows an example of the video signal DAT. FIG. 4C shows an example of the vertical sync signal VD. FIG. 4D shows an example of the horizontal sync signal HD. The clock signal CLK is continuously output except in a vertical blanking period Tvb. In the vertical blanking period Tvb, the clock signal CLK is output only in a period including a period during which the sync signal Sync Code 1 shown in FIG. 3A is output and a period in the vicinity thereof. The video signal DAT is output in a period during which the clock signal CLK shown in FIG. 4A is output.

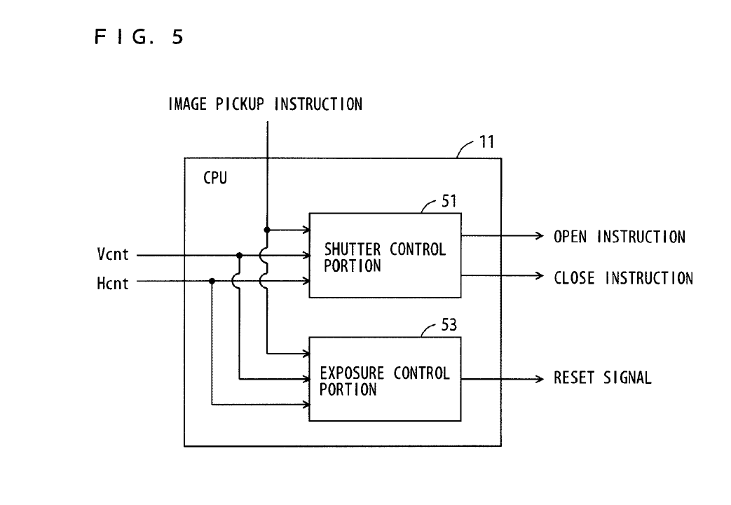

FIG. 5 is a block diagram showing an example of an overall function of the CPU. Referring to FIG. 5, CPU 11 includes a shutter control portion 51 controlling mechanical shutter 15 and an exposure control portion 53 controlling image sensor 17.

Shutter control portion 51 and exposure control portion 53 each receive the horizontal sync signal count value Vcnt and the pixel count value Hcnt from counter 43 of conversion unit 19 and receives an image pickup instruction from operation unit 25. Operation unit 25 outputs an image pickup instruction to CPU 11 when the user presses the shutter button. Shutter control portion 51 determines a timing of closing mechanical shutter 15, based on the horizontal sync signal count value Vcnt and the pixel count value Hcnt. The exposure time is set using the output interval of the horizontal sync signal as a unit of time. The timing of closing mechanical shutter 15 is determined based on the timing at which the horizontal sync signal is input. More specifically, the timing of closing mechanical shutter 15 is determined based on the horizontal sync signal count value Vcnt and the pixel count value Hcnt in the period in the vicinity of the point of time when the horizontal sync signal is input.

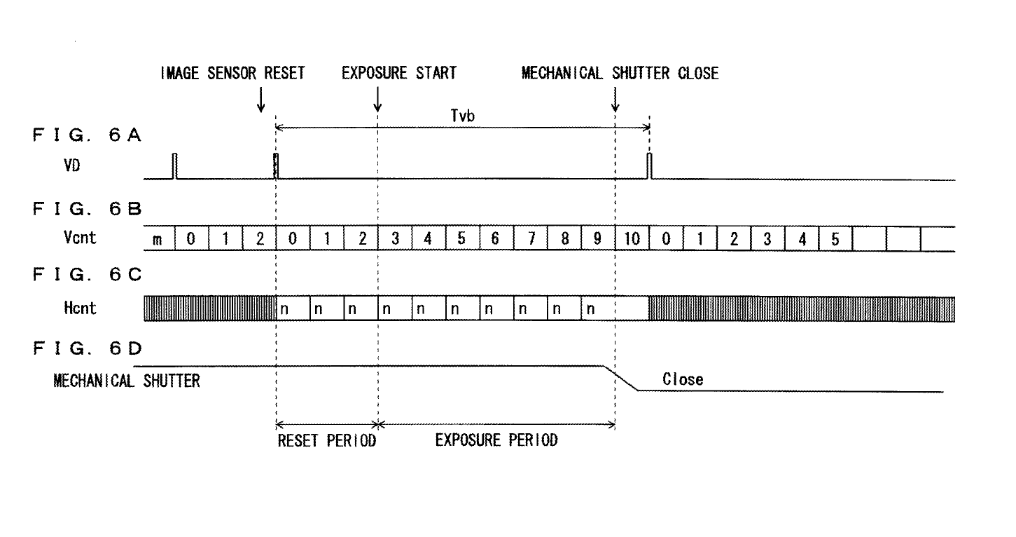

The function of CPU 11 will be described below using the horizontal sync signal count value Vcnt and the pixel count value Hcnt that are input to CPU 11. FIG. 6A to FIG. 6D show an example of the vertical sync signal, the count value of the horizontal sync signal, and the count value of a pixel, and a mechanical shutter open/closed state.

Referring to FIG. 5 and FIG. 6A to FIG. 6D, exposure control portion 53 outputs a reset signal to image sensor 17 in response to input of the image pickup instruction. After the reset signal is input from exposure control portion 53, image sensor 17 is reset, and the vertical blanking period Tvb is also reset. Therefore, image sensor 17 starts a new blanking period at the point of time when the reset signal is input. The reset period from when image sensor 17 starts reset to when it completes the reset is predetermined. Here, the reset period is triple the output interval of the horizontal sync signal HD.

Shutter control portion 51 determines the timing of closing the shutter based on the horizontal sync signal count value Vcnt and the pixel count value Hcnt, in response to input of the image pickup instruction. Specifically, since image sensor 17 is reset when the reset signal is input, CPU 11 detects that image sensor 17 starts reset when the horizontal sync signal count value Vcnt having a value “0” and the pixel count value Hcnt having a value “0” are input. Since the reset period is triple the output interval of the horizontal sync signal HD, CPU 11 determines that the reset of image sensor 17 terminates when the horizontal sync signal count value Vcnt having a value “3” and the pixel count value Hcnt having a value “0” are input. CPU 11 then determines the determined point of time as the timing of opening the shutter. A constant m shown in FIG. 6B shows the number of lines of image data of a screen. A constant n shows the maximum value of the pixel count value Hcnt which is incremented by the clock signal CLK input in the period in the vicinity of the point of time when the horizontal sync signal is input in a blanking period.

As the exposure time is predetermined, the horizontal sync signal count value Vcnt corresponding to the time when the exposure time has elapsed is determined. For example, when the exposure time is ten times as long as the output interval of the horizontal sync signal HD, the time when the horizontal sync signal count value Vcnt having a value of “13” and the pixel count value Hcnt having a value of “0” are input is determined as the timing at which the exposure period of image sensor 17 terminates. When the exposure period is seven times as long as the output interval of the horizontal sync signal HD, as shown in FIG. 6A to FIG. 6D, the time when the horizontal sync signal count value Vcnt having a value of “10” and the pixel count value Hcnt having a value of “0” are input is determined as the timing at which the exposure time of image sensor 17 terminates.

Image sensor 17 starts output of the second low voltage differential signal when the exposure time has elapsed. Therefore, CPU 11 determines the timing at which image sensor 17 starts outputting the second low voltage differential signal, based on the horizontal sync signal count value Vcnt and the pixel count value Hcnt.

In the present embodiment, the control process of opening/closing mechanical shutter 15 executed by CPU 11 has been described as an example of the processing in synchronization with the horizontal sync signal output by image sensor 17 in a vertical blanking period. However, the processing in synchronization with the horizontal sync signal output by image sensor 17 is not limited to the foregoing case. For example, the horizontal sync signal output by image sensor 17 in a vertical blanking period may be used in a pipeline process of processing image data output from image sensor 17 and stored in SDRAM 21.

As described above, image sensor 17 in the present embodiment outputs only a horizontal sync signal as a low voltage differential signal in a vertical blanking period, thereby bringing digital still camera 1 in synchronization with image sensor 17.

The horizontal sync signal output by image sensor 17 in a vertical blanking period is used to determine the timing of terminating the time of photoelectric transduction by image sensor 17, in other words, the timing of closing mechanical shutter 15, thereby eliminating the need for SRAM 75 and

PLL 73, which are conventionally necessary for synchronization with image sensor 17 during a vertical blanking period. Accordingly, the number of components can be reduced.

Although the present invention has been described and illustrated in detail, it is clearly understood that the same is by way of illustration and example only and is not to be taken by way of limitation, the spirit and scope of the present invention being limited only by the terms of the appended claims.

1. An image sensor comprising:
a plurality of photoelectric transduction elements arranged in a two-dimensional array; and
an output unit outputting a video signal generated from electric charges accumulated by said plurality of photoelectric transduction elements, and sync codes corresponding to a horizontal sync signal and a vertical sync signal indicating predetermined intervals, as low voltage differential signals synchronized with a prescribed clock,
wherein said output unit outputs only the sync code corresponding to a horizontal sync signal as a low voltage differential signal in a blanking period, among said video signal and said sync codes corresponding to a horizontal sync signal and a vertical sync signal.

2. An image pickup apparatus comprising:
an image sensor outputting a video signal generated from electric charges accumulated by a plurality of photoelectric transduction elements, and sync codes corresponding to a horizontal sync signal and a vertical sync signal indicating predetermined intervals, as low voltage differential signals synchronized with a prescribed clock, said image sensor outputting only the sync code corresponding to a horizontal sync signal as a low voltage differential signal in a blanking period, among said video signal and said sync codes corresponding to a horizontal sync signal and a vertical sync signal; and
an image pickup control unit to control said image sensor,
wherein said image pickup control unit determines a timing at which photoelectric transduction terminates after reset of said image sensor, using the sync code corresponding to a horizontal sync signal included in the low voltage differential signal output by said image sensor during said blanking period.

3. The image pickup apparatus according to claim 2, further comprising:
a lens to form a subject image on said image sensor; and
a mechanical shutter provided between said lens and said image sensor,
wherein said image pickup control unit closes said mechanical shutter at said determined timing.

4. An image sensor comprising:
a plurality of photoelectric transduction elements arranged in a two-dimensional array; and
an output unit outputting a video signal generated from electric charges accumulated by said plurality of photoelectric transduction elements, and sync codes corresponding to a horizontal sync signal and a vertical sync signal indicating predetermined intervals, as low voltage differential signals synchronized with a prescribed clock,
wherein said output unit, in a blanking period, outputs the sync code corresponding to a horizontal sync signal as a low voltage differential signal, and limits outputting said video signal and said sync codes corresponding to a vertical sync signal as a low voltage differential signal.

5. An image pickup apparatus comprising:
An image sensor outputting a video signal generated from electric charges accumulated by a plurality of photoelectric transduction elements, and sync codes corresponding to a horizontal sync signal and a vertical sync signal indicating predetermined intervals, as low voltage differential signals synchronized with a prescribed clock, said image sensor, in a blanking period, outputting the sync code corresponding to a horizontal sync signal as a low voltage differential signal, and limiting outputting said sync codes corresponding to a vertical sync signal as a low voltage differential signal; and
an image pickup control unit to control said image sensor,
wherein said image pickup control unit determines a timing at which photoelectric transduction terminates after reset of said image sensor, using the sync code corresponding to a horizontal sync signal included in the low voltage differential signal output by said image sensor during said blanking period.

6. The image pickup apparatus according to claim 5, further comprising:
a lens to form a subject image on said image sensor; and
a mechanical shutter provided between said lens and said image sensor,
wherein said image pickup control unit closes said mechanical shutter at said determined timing.
